(19) United States
(12) Patent Application Publication
(10) Pub. No.: US 2019/0194451 A1
(43) Pub. Date: Jun. 27, 2019

(54) COMPOSITION BASED ON POLYACTIC ACID

(71) Applicant: SYNBRA TECHNOLOGY B.V., Etten-Leur (NL)

(72) Inventors: Karin MOLENVELD, ETTEN-LEUR (NL); Josephus Petrus Maria DE JONG, ETTEN-LEUR (NL); Jan NOORDEGRAAF, ETTEN-LEUR (NL); Kenneth VAN DEN HOONAARD, ETTEN-LEUR (NL)

(21) Appl. No.: 16/301,359

(22) PCT Filed: May 12, 2017
(86) PCT No.: PCT/NL2017/050299

§ 371 Date: Nov. 13, 2018

(30) Foreign Application Priority Data
May 13, 2016 (NL) 2016774

(51) Int. Cl. C08L 67/04; C08L 33/12; C08J 9/00; C08J 9/18; C08J 9/228; C08J 9/224; C08J 3/20

(52) U.S. Cl. CPC C08L 67/04; C08J 2433/12; C08J 9/0066; C08J 9/18; C08J 9/228; C08J 9/224; C08J 3/201; C08L 2203/14; C08J 2203/06; C08L 2205/03; C08L 2205/025; C08J 2367/04; C08J 2467/04; C08J 2333/12; C08L 33/12

(57) ABSTRACT

The present invention relates to a composition based on polylactic acid, comprising polylactic acid or a compound derived therefrom, and one or more additives, wherein polymethylmethacrylate is used as at least one additive. The amount of poly-methylmethacrylate is preferably at least 5 wt %, based on the total amount of polylactic acid or a compound derived therefrom, based on weight, in the final composition.

The present invention relates to a composition comprising polylactic acid or a compound derived therefrom, and one or more additives. The present invention further relates to a method for manufacturing a foamed moulded part, comprising extrusion of polylactic acid or a compound derived therefrom in the presence of one or more additives, and the present invention also relates to a moulded part obtained by said method.

Moulded parts based on polylactic acid are known per se, for example from International application WO 2014/158014 in the name of the present applicant. A method is known from the aforementioned application for preparing expanded PLA (polylactic acid) foam, comprising the following steps: a) supplying PLA foamed pellets, b) heating the PLA foamed pellets to a so-called annealing temperature and saturating with a blowing agent, c) maintaining the PLA pellets at the annealing temperature and saturating with the blowing agent, d) lowering the pressure and cooling the saturated PLA pellets from step C) to room temperature with formation of expanded PLA foam.

International application WO 2008/130225 in the name of the present applicant discloses a method for manufacturing a foamed moulded part, comprising the extrusion of polylactic acid in an extruder.

Other publications concerning moulded parts based on PLA are for example European applications EP 2 334 719 and EP 2 137 250, both in the name of the present applicant.

From EP 1 683 828, resin particles based on expandable polylactic acid are known, containing (a) a base resin that contains a polylactic acid resin with at least 50 mol % of lactic acid monomer units, (b) a polyolefin wax in an amount of 0.0001-1 part by weight per 100 parts by weight of base resin, and (c) a blowing agent in an amount from 1 to 30 wt %, relative to the weight of the resin particles.

U.S. application US 2007/0032577 relates to a biaxially drawn film containing a polylactic acid with a weight-average molecular weight of 50 000 or higher and at least one compound selected from cellulose esters, poly(meth)acrylates and polyvinyl compounds with a glass transition temperature (Tg) of 60° C. or higher.

Chinese publication CN 101362833 discloses a foam mixture based on a combination of polylactic acid and polymethylmethacrylate.

The article by Samuel, C., et al.; “Biobased Poly(lactides)/Poly(methyl methacrylate) Blends: A Perfect Association for Durable and Smart Applications?”; Proceedings of PPS-30, AIP Conf. Proc. 1664, (2015) relates to the introduction of polymethylmethacrylate (PMMA) into materials based on polylactides for creating miscible polymer mixtures provided with specific functionalities and mechanical properties, especially the glass transition temperature and the heat deflection temperature.

Another article by Samuel C., et al.; “PLLA/PMMA blends: A shear-induced miscibility with tunable morphologies and properties?”; Polymer, (2013), Vol. 54, pp 3931-3939 relates to mixtures of polylactic acid and PMMA, where the aforementioned mixtures are obtained by means of a solvent-casting method or by twin-screw extrusion, and then are investigated for temperature resistance.

Polylactic acid (PLA) is a renewable biodegradable material that is used inter alia in the packaging industry. Polylactic acid is a general term for polymers based on lactic acid monomers, where the polylactic acid structure can vary, depending on the composition, from completely amorphous to semicrystalline or crystalline.

Polylactic acid can be produced from lactic acid products obtained by fermentation of starch or sugars derived for example from sugar beet, sugar cane or maize.

Lactic acid is the monomer from which polylactic acid is constructed and this monomer occurs as two stereoisomers, namely L-lactic acid and D-lactic acid.

Polylactic acid thus contains a certain proportion of L-lactic acid monomers and a certain proportion of D-lactic acid monomers. The ratio between the L- and D-lactic acid monomers in polylactic acid determines its properties. The term D-value or D-content is also used. This means the percentage of D-lactic acid monomers in polylactic acid. Polylactic acid that is currently commercially available has an L:D ratio from 100:0 to 75:25; in other words a D-content from 0 to 25%, or between 0 and 0.25. When polylactic acid contains more than approx. 12% D-lactic acid, it can no longer crystallize and it is thus completely amorphous. When the D-content is at most 5%, it is called semicrystalline polylactic acid. The crystallinity of polylactic acid can be determined by differential scanning calorimetry (DSC). Semicrystalline means that the polymer can crystallize and can also melt. This applies to all PLA that is not amorphous. Semicrystalline PLA differs from amorphous PLA in that it has a melting point as well as a glass-transition temperature. Because it has a melting point, it can crystallize or melt, and whether the one or the other occurs will depend on the thermal history. It may be said that apart from amorphous PLA there is only semicrystalline PLA, because the completely crystalline form only occurs in theory. It may be said that the lower the D-content, the higher the crystallinity of polylactic acid. The D-content is generally determined by a known method, such as so-called R-lactate determination using gas-liquid chromatography (GLC) after complete hydrolysis of the polymer. Another standard method is determination from optical rotation (measured in chloroform using a Jasco DIP-140 polarimeter at a wavelength of 589 nm).

One method for the further processing of PLA granules comprises a so-called pre-foaming operation, in which a defined amount of steam is led through a bed of PLA granules in an expansion tank, so that the blowing agent present in the polymer granules is vaporized and foaming of the granules takes place. Generally, after pre-foaming, a coating is applied and it is impregnated with a blowing agent again. The granules pretreated in this way are put in a suitable mould, and the granules are further expanded under the action of steam. In this way, the desired moulded part is obtained, because the pre-foamed granules undergo further expansion under the effect of steam and in addition fuse to form a single moulded part.

A disadvantage of such a method is the low temperature resistance of the starting materials, as a result of which no dimensionally stable final products can be obtained.

Another disadvantage of such a method is that the final product obtained is susceptible to degeneration, so that product life is limited considerably.

One aspect of the present invention is the supply of particulate polylactic acid that displays improved thermal stability during processing to form foamed moulded parts.

Another aspect of the present invention is the supply of particulate polylactic acid that displays improved fusing behaviour and improved mechanical properties and thermal stability during processing to form foamed moulded parts.

Yet another aspect of the present invention is the supply of particulate polylactic acid that displays high temperature resistance during moulding and improved resistance to hydrolysis during processing to form foamed moulded parts.

The present invention thus relates to a composition based on polylactic acid, comprising polylactic acid or a compound derived therefrom, and one or more additives, wherein polymethylmethacrylate is used as at least one additive.

On employing addition of polymethylmethacrylate (PMMA) to the composition based on polylactic acid or a compound derived therefrom, the present inventors found that a composition is obtained that possesses surprisingly improved temperature resistance during moulding of the composition. An example of such processing comprises mixing of PLA granules and polymethylmethacrylate, after which, after impregnation with an impregnating agent, foaming is carried out at a pressure of for example 20 bar. Then the material obtained is impregnated again as foam and moulded in a mould at a certain steam pressure. Addition of polymethylmethacrylate has the effect of increasing the temperature resistance during forming.

The present inventors also found that in the past, certain types of PLA were always applied, namely PLA with a defined L/D lactide ratio. The reason for this was to have just enough crystallization so that crystallization did not interfere in the moulding step, but did contribute in the final product. On implementing the present invention, however, it was found that it is possible to use highly crystalline PLA grades, especially by employing these materials in combination with PMMA. According to the present invention, it has thus been found possible to work with the entire range of compositions of PLA, especially by appropriate adjustment of the amount of PMMA. The present inventors found that by adding PMMA, PLA with a composition between 95/5 and 100/0 (L-lactide/D-lactide) can be used. It was thus found possible to influence the crystallization rate in the method for manufacturing foamed moulded parts based on polylactic acid or a compound derived therefrom.

The present inventors further found that addition of polymethylmethacrylate to polylactic acid has the effect of increasing the Tg of polylactic acid. The present inventors assume that, as a result, the Tg of a PLA/PMMA mixture will lie between the Tg of PLA at 55° C. and the Tg of PMMA at 105° C. This implies that addition of PMMA to PLA will increase its Tg, so that its thermal stability increases and higher processing temperatures are possible.

For an increase in temperature resistance, it is especially desirable that the amount of polymethylmethacrylate is at least 5 wt %, especially at least 10 wt %, based on the total amount of polylactic acid or a compound derived therefrom, based on weight, in the final composition.

The present inventors have found that in order to increase the temperature resistance, the amount of polymethylmethacrylate is in particular at most 50 wt %, based on the total amount of polylactic acid or a compound derived therefrom, based on weight, in the final composition.

In a particular embodiment, it is desirable for the ratio of PLA to PMMA to be between 1 and 50%, in particular between 5 and 50%, more particularly between 10 and 30%.

In addition to the intended increase in temperature resistance, it is also desirable to improve the durability or stability, especially in damp conditions, of the composition based on polylactic acid or a compound derived therefrom. Thus, the present inventors found that it is desirable for the aforementioned composition to contain hydrotalcite as well. In particular, the amount of hydrotalcite is at least 0.2 wt % and at most 2.0 wt %, based on the weight of the final composition.

The present invention further relates to a method for manufacturing a foamed moulded part, comprising extrusion of polylactic acid or a compound derived therefrom in the presence of one or more additives, then impregnation of the extruded product with an impregnating agent, pre-foaming the impregnated composition thus obtained, coating the foamed beads thus obtained, impregnating the coated, foamed beads with an impregnating agent and moulding the impregnated, coated, foamed beads thus obtained, the aforementioned extrusion being carried out in the presence of polymethylmethacrylate. The mould employed in such a method is provided with small openings so that, during expansion, the blowing agent still present and any steam and/or hot air can escape while the granules fuse to form the desired shape. The dimensions and shape of the mould are in principle unlimited, and for example both blocks for the building industry and meat trays or fish boxes may be obtained.

More particularly, the present invention relates to a particular embodiment of a method for manufacturing a foamed moulded part, said method further comprising the following steps:

a) providing microgranules,

b) impregnating the aforementioned microgranules with a blowing agent at reduced temperature,

c) pre-foaming the microgranules from step b) into foamed beads,

d) applying a coating on the foamed beads from step c),

e) impregnating the foamed beads from step d) with an impregnating agent, and

f) moulding the intended final product on the basis of the material from step e) in a mould.

In a particular embodiment of the aforementioned method, step d) may be omitted, with step e) being carried out on the foamed beads from step c).

The following materials may be mentioned as a suitable coating for PLA particulate foam: polyvinyl acetate, polymers based on polyvinyl acetate, polyvinyl alcohol, polyurethane, polyacrylic, polycaprolactone, polyester, polyester amide, copolymers based on polylactic acid, protein-based polymers, polysaccharide, natural wax and fat, or combinations thereof. The application of such a coating or covering makes it possible to produce formed products with good fusing together of the individual granules, said fusing together also being applicable for foam based on PLA/PMMA.

With such a method, it is preferable, in the aforementioned extrusion, for the amount of polymethylmethacrylate added to be at least 5 wt %, preferably at least 10 wt %, based on the total amount of polylactic acid or a compound derived therefrom, based on weight, present during the aforementioned extrusion.

From the viewpoint of improving the durability and/or stability, it is desirable for the aforementioned extrusion to be carried out in the presence of hydrotalcite, wherein the amount of hydrotalcite is at least 0.2 wt % and at most 2.0 wt %, based on the weight of the final composition.

The aforementioned moulding step is preferably carried out in the presence of hot air, steam, or a combination thereof. The aforementioned impregnating step is preferably carried out with an impregnating agent selected from the group comprising CO₂, MTBE, nitrogen, air, (iso)pentane, propane and butane, or a combination thereof.

The present invention relates in particular to a foamed moulded part obtained by carrying out the method discussed above, wherein Tₘₐₓ of the aforementioned moulded part is at least 85° C.

This foamed moulded part has a value for Tₘₐₓ of at most 135° C.

The particulate polylactic acid foam that can be used in the method according to the present invention may be amorphous, semicrystalline or a mixture of the two. Polylactic acid is commercially available as amorphous or semicrystalline polylactic acid under the brand name Ingeo™ (for example Ingeo™ 4060D, Natureworks) or Synterra (for example Synterra PLLA 1510, Synbra Technology BV).

It is also possible to mix the polylactic acid with other additives, such as (biodegradable) polymers and/or fillers. Examples of these are a copolyester of butanediol, adipic acid and terephthalic acid (available under the name Ecoflex from BASF), starch, chalk, mica, activated carbon, talc, soot, starch, flour, kaolin, or cellulose. It is also desirable in certain embodiments to mix polylactic acid with one or more of the so-called (partially) bio-based thermoplastic materials, which may or may not be compostable, for example PHA (PolyHydroxyAlkanoate), PEF (PolyEthyleneFuranoate), PCL (Polycaprolactone), PHB (Polyhydroxybutyrate), PBAT (PolyButyleneAdipateTerephthalate), PBS (Polybutylene succinate), PTT (PolyTrimethyleneTerephthalate), BioPET (BioPolyEthyleneTerephthalate), BioPE (BioPolyEthylene), BioPA (BioPolyAmide). The present invention will be explained in more detail below, on the basis of a number of examples.

An amount of polylactic acid was mixed with polymethylmethacrylate, after which moulding was carried out. A number of mechanical properties of the final product thus obtained were determined. The measured results are presented in the following table.

The experiments were carried out with a mixture as shown in Table 1 using a twin-screw compounding extruder (Berstorff ZE7536xD UTX). A homogeneous melt was transported from the extruder to the extruder head (Gala underwater granulator A6) via a so-called melt pump. Said mould had 192 orifices, each with a diameter of 0.7 mm, and the PLA particulate composition had a particle diameter of 1.1-1.5 mm. The particulate PLA composition was then impregnated with a blowing agent (CO₂) in a pressure vessel at a pressure of 16 bar for 20 hours. After impregnation, the PLA composition contained about 7 wt % CO₂. Then the PLA particulate composition was pre-foamed using hot air (at a temperature of about 90° C.) for 1 minute. The pre-foamed PLA particulate composition had a density of about 30 g/l. The pre-foamed PLA particulate composition was then provided with a coating in a fluidized-bed reactor. An amount of coating of 5 wt %, based on the solids content, was applied by means of a liquid Epotal solution. After drying, the pre-foamed PLA particulate composition was impregnated again with a blowing agent (CO₂) in a pressure vessel at a pressure of 7 bar for 4 hours. After re-impregnation, the pre-foamed particulate PLA composition contained about 7 wt % CO₂. Then the PLA particulate composition was sent to an industrial production unit for foamed formed products, where further expansion and fusing-together of the particulate PLA took place with steam, to give a moulded foamed product. The results for the fusing-together of the particulate PLA and the mechanical strength of the moulded product obtained are presented in Table 1.

TABLE 1
compositions based on PLA and PMMA

| | | | ρ | Tₘₐₓ | | Breaking | Tensile |
|---|---|---|---|---|---|---|---|
| PMMA/PLA | | X % | kg/ | during | CO₂ | strength | strength |
| mix | Tg | foam | m³ | forming | pressure | kPa | kPa |
| BF1505 | 58 | 20.57 | 30 | 80 | 5.5 | 134 | 118 |
| (reference) | | | | | | | |
| 5% PMMA + | 58 | 19.82 | 31 | 85 | 5.5 | 79 | 86 |
| BF1505 | | | | | | | |
| 10 PMMA + | 59 | 21.21 | 30 | 95 | 4.5 | 118 | 92 |
| BF1505 | | | | | | | |
| 15 PMMA + | 60 | 22.30 | 40 | 100 | 4 | 149 | 146 |
| BF1505 | | | | | | | |
| 20 PMMA + | 61 | 22.30 | 40 | 100 | 3 | 132 | 112 |
| BF1505 | | | | | | | |
| 30 PMMA + | 62 | 13.12 | 32 | 125 | 3 | 350 | 294 |
| BF1505* | | | | | | | |
| 50 PMMA + | 68 | 3.2 | 38 | 100 | 3 | n.a. | n.a. |
| BF1505* | | | | | | | |
| 30 PMMA + + | 62 | 24 | 34 | 115 | 1.5 | 117 | 64 |
| PLLA | | | | | | | |

In the table, the indication * relates to another production machine.

The PMMA used in the aforementioned examples is of the Altuglas V920 type, BF1505 is Synterra PLA (Mn: 150 kDa, D content: 4-5%) and PLLA is Synterra PLLA (Mn: 150 kDa, D content:<0.5%). In the table, the term “X % FOAM” denotes the degree of crystallization (%).

It can be seen from Table 1 that the amount of PMMA only affects the crystallinity of PLA at a large amount. Thus, the crystallinity decreases in the PMMA/BF1505 blends at an amount of more than 20% PMMA. This means that final products based on blends with less than 20% PMMA maintain the same level of crystallinity, so that the thermal properties (dimensional stability above the glass-transition temperature) at least remain constant. In addition, the glass-transition temperature is somewhat higher, which is also to be regarded as favourable. If more PMMA is added, the crystallinity decreases, so that the dimensional stability of the resultant final products might be reduced above the glass-transition temperature. However, the glass-transition temperature still rises with more PMMA, so it depends on the temperature when the dimensional stability will play a critical role.

However, the larger amount of PMMA does have an important advantage during forming of the final products, as it can also be seen from Table 1 that the maximum temperature of the mould can be higher, and moulding can be done with less blowing agent. As a result, less cooling is required during moulding and the cycle time becomes shorter, and products will be less expensive.

Another important point is that with an increased amount of PMMA, the crystallinity is admittedly lower, but that may be regarded as an advantage during foaming. Thus, crystallization is on the one hand an advantage in the final product (gives dimensional stability at temperatures above the glass-transition temperature), but during foaming it is a disadvantage, because foaming becomes more difficult as the crystallinity increases. The advantage of suppressing crystallization with PMMA can be seen from the last sample in Table 1. This last sample is a blend with PLLA. One would assume that this type of PLA will crystallize so quickly that the material is unusable in combination with BioFoam®. It is now clear from experiments that the material can indeed be processed and there has been mention of crystallinity that is comparable to BF1505 (without PMMA the crystallinity would be much higher and therefore low density would become impossible). In accordance with a usual method, foamed moulded parts were obtained based on PLA that was obtained with a 95/5 (L-lactide/D-lactide) composition. Because such a PLA is not stereochemically pure, it crystallizes slowly enough for pre-foaming and moulding to be possible. However, the last example in Table 1 concerns a PLLA/PMMA blend. Normally, PLLA (100/0 L-lactide/D-lactide) would crystallize too quickly, but the present inventors have now found that crystallization is favourably delayed by the presence of PMMA, so that the aforementioned type of PLA is still usable for the manufacture of foamed moulded parts.

It is clear from the table that at an amount of 5 wt % PMMA, an increase in temperature resistance (Tₘₐₓ) of 5° C. is achieved. There is also mention of lower CO₂ concentrations that are then necessary. The highest temperature resistance (Tₘₐₓ) is obtained with an amount of PMMA of 30 wt %.

The present inventors thus found that the advantage of adding PMMA is that it results in better processing, namely expansion with much less CO₂, because this is retained much better, and the possibility of forming (moulding) at a higher temperature (due to the fact that PMMA provides stabilization, and on account of the more favourable pressure reduction). In certain embodiments it is also possible to apply moulding without coating.

Determination of Stability in the Melt

Compositions were prepared based on PLA BF 1505 (Synbra Technology) with a hydrotalcite content of 5 wt % HT4AU or HT4A (Kisuma Chemicals B.V.). The compositions obtained were dried at 83° C. for 4 hours using a drying installation. The following table shows the MFI (melt flow index, measured at 190° C. using a Zwick extrusion plastometer) of the compositions after 5 and 55 minutes. PLA BF1505 shows a significant increase in MFI, which is a clear indication of degradation, whereas the compositions with hydrotalcite remain stable.

TABLE 2
MFI measurements

| | drying for 4 h at 83° C. after extrusion | | |
|---|---|---|---|
| Sample | 5 min | 55 min | |
| BF1505-200° C. | 20.76 | 35.52 | MFI |
| BF-1505-4AU-200° C. | 17.45 | 16.58 | (g/10 min) |
| BF-1505-4A-200° C. | 14.58 | 14.56 | |

In addition, extrusion tests were carried out with compositions based on hydrotalcite and PLA. Foamed moulded parts were obtained after impregnation with CO₂.

TABLE 3
addition of hydrotalcite and moulded parts obtained g/l.

| | | Other type of | |
|---|---|---|---|
| | | nucleating | Foam density |
| Sample | hydrotalcite | agent | g/l |
| I | 0.5% A10XC | | 19.0 |
| VIII | 0.5 HT-4AU | | 16.3 |
| IX | 0.5 HT-4A | | 16.8 |
| X | 0.5% Sorbacid 911 | | 12.8 |
| XI | 0.5% Sorbacid 944 | | 13.0 |
| XII | 0.5% Sorbacid 944 | 0.5 A10XC | 11.9 |
| XIII | 0.5% Sorbacid 911 | 0.5 A10XC | 15.7 |

TABLE 4
moulded parts based on mixtures of PLA and hydrotalcite

| | | | Tmax | Valve position | Breaking | Tensile |
|---|---|---|---|---|---|---|
| | X % | ρ | mould | max | strength | strength |
| BF1505 | 20.57 | 30 | 80 | 60 | 134 | 118 |
| BF1505 + | 24.66 | 34 | 90 | 55 | 115 | 211 |
| HT4A 1% | | | | | | |
| BF1505 + | 39.37 | 42 | 90 | 80 | 143 | 205 |
| HT4U 1% | | | | | | |

It follows from Table 4 that the moulded parts based on mixtures of PLA and hydrotalcite (Hydrotalcite HT4A and HT4U) display higher temperature resistance during moulding and improved resistance to hydrolysis.

1. A composition based on polylactic acid, comprising polylactic acid or a compound derived therefrom, and one or more additives, characterized in that polymethylmethacrylate is used as at least one additive.

2. The composition of claim 1, characterized in that the amount of polymethylmethacrylate is at least 5 wt %, based on the total amount of polylactic acid or a compound derived therefrom, based on weight, in the final composition.

3. The composition of claim 1, characterized in that the amount of polymethylmethacrylate is at least 10 wt %, based on the total amount of polylactic acid or a compound derived therefrom, based on weight, in the final composition.

4. The composition of claim 1, characterized in that the amount of polymethylmethacrylate is at most 50 wt %, based on the total amount of polylactic acid or a compound derived therefrom, based on weight, in the final composition.

5. The composition of claim 1, characterized in that a polylactic acid with a composition between 95/5 and 100/0 (L-lactide/D-lactide) is used as polylactic acid or a compound derived therefrom.

6. The composition of claim 1, characterized in that the aforementioned composition further contains hydrotalcite.

7. The composition of claim 6, characterized in that the amount of hydrotalcite is at least 0.2 wt % and at most 2.0 wt %, based on the weight of the final composition.

8. A method for manufacturing a foamed moulded part, comprising extrusion of polylactic acid or a compound derived therefrom in the presence of one or more additives, impregnation with an impregnating agent, pre-foaming and moulding, characterized in that the aforementioned extrusion is carried out in the presence of polymethylmethacrylate.

9. The method of claim 8, characterized in that in the aforementioned extrusion the amount of polymethylmethacrylate added is at least 5 wt %, based on the total amount of polylactic acid or a compound derived therefrom, based on weight, present during the aforementioned extrusion.

10. The method of claim 8, characterized in that after pre-foaming, the resultant pre-foamed beads are provided with a coating.

11. The method of claim 10, characterized in that the coated, pre-foamed beads are treated with an impregnating agent, after which the moulding is carried out.

12. The method of claim 8, characterized in that polylactic acid or a compound derived therefrom is mixed with one or more materials selected from the group comprising PHA (PolyHydroxyAlkanoate), PEF (PolyEthyleneFuranoate), PCL (Polycaprolactone), PHB (Polyhydroxybutyrate), PBAT (PolyButyleneAdipateTerephthalate), PBS (Polybutylene succinate), PTT (PolyTrimethyleneTerephthalate), BioPET (BioPolyEthyleneTerephthalate), BioPE (BioPolyEthylene) and BioPA (BioPolyAmide).

13. The method of claim 8, characterized in that the aforementioned extrusion is carried out in the presence of hydrotalcite, wherein the amount of hydrotalcite is at least 0.2 wt % and at most 2.0 wt %, based on the weight of the final composition.

14. The method of claim 8, characterized in that the aforementioned moulding step is carried out in the presence of hot air, steam, or a combination thereof.

15. The method of claim 8, characterized in that the aforementioned impregnating step is carried out with an impregnating agent selected from the group comprising CO₂, MTBE, nitrogen, air, (iso)pentane, propane and butane, or a combination thereof.

16. A foamed moulded part, obtained by carrying out the method as defined in claim 8, characterized in that Tₘₐₓ of the aforementioned moulded part is at least 85° C.

17. The foamed moulded part of claim 16, characterized in that Tₘₐₓ of the aforementioned moulded part is at most 135° C.

18. The foamed moulded part of claim 16, characterized in that the moulded part comprises polylactic acid with a composition between 95/5 and 100/0 (L-lactide/D-lactide).
